(19) United States
(12) Patent Application Publication
(10) Pub. No.: US 2020/0142039 A1
(43) Pub. Date: May 7, 2020

(54) OBJECT MEASUREMENT FOR LIGHT DETECTION AND RANGING SYSTEM

(71) Applicant: SZ DJI TECHNOLOGY CO., LTD., Shenzhen (CN)

(72) Inventors: Xiang LIU, Shenzhen (CN); Ke WANG, Shenzhen (CN); Xiaoping HONG, Shenzhen (CN)

(21) Appl. No.: 16/719,426

(22) Filed: Dec. 18, 2019

Related U.S. Application Data
(63) Continuation of application No. PCT/CN2017/091215, filed on Jun. 30, 2017.

(51) Int. Cl. G01S 7/4865; G01S 17/933; G01S 17/10

(52) U.S. Cl. CPC G01S 7/4865; G01S 17/10; G01S 17/933

(57) ABSTRACT

A method includes emitting an outbound light pulse by a light detection and ranging (LIDAR) device, and receiving a first light pulse and a second light pulse at the LIDAR device. The first light pulse is indicative of a reflection of the outbound light pulse by an internal part of the LIDAR device. The second light pulse is indicative of a reflection of the outbound light pulse by a surrounding object. The method further includes, responsive to an overlap between electronic signals representing the first and second light pulses, deriving an estimated time value associated with the second light pulse based on a piece of timing information in a trailing section of the second light pulse, and determining a distance of the surrounding object from the LIDAR device based on the estimated time value associated with the second light pulse.

### CROSS-REFERENCE TO RELATED APPLICATION

This application is a continuation of International Application No. PCT/CN2017/091215, filed Jun. 30, 2017, the entire content of which is incorporated herein by reference.

### TECHNICAL FIELD

The present disclosure is directed generally to electronic signal processing, and more specifically, to components, systems and techniques associated with signal processing in light detection and ranging (LIDAR) applications.

### BACKGROUND

With their ever increasing performance and lowering cost, unmanned vehicles are now extensively used in many fields. Representative missions include crop surveillance, real estate photography, inspection of buildings and other structures, fire and safety missions, border patrols, and product delivery, among others. For obstacle detection as well as for other functionalities, it is beneficial for unmanned vehicles s to be equipped with obstacle detection and surrounding environment scanning devices. Light detection and ranging (LIDAR, also known as “light radar”) offers reliable and accurate detection. However, due to limitations of the internal structures of LIDAR, current LIDAR systems are unable to measure a surrounding object that is physically too close to the system. Accordingly, there remains a need for improved techniques for implementing LIDAR systems carried by unmanned vehicles and other objects.

### SUMMARY OF PARTICULAR EMBODIMENTS

The present disclosure is directed to components, systems and techniques associated with signal processing in light detection and ranging (LIDAR) applications.

In one exemplary aspect, a method of signal processing is disclosed. The method includes emitting, by a light detection and ranging (LIDAR) device, an outbound light pulse; receiving, at the LIDAR device, a first light pulse indicative of a reflection of the outbound light pulse by an internal part of the LIDAR device; receiving, at the LIDAR device, a second light pulse indicative of a reflection of the outbound light pulse by a surrounding object; detecting or observing an overlap between electronic signals representing the first and second light pulses, wherein the overlap causes a loss of a piece of timing information in a leading section of the second light pulse; deriving, in response to the overlap, an estimated time value associated with the second light pulse based on a first piece of timing information in a trailing section of the second light pulse; and determining a distance of the surrounding object from the LIDAR device based on the estimated time value associated with the second light pulse.

In another exemplary aspect, a method of signal processing is disclosed. The method includes emitting, by a light detection and ranging (LIDAR) device, an outbound light pulse; receiving, at the LIDAR device, a first light pulse indicative of a reflection of the outbound light pulse by a first object; receiving, at the LIDAR device, a second light pulse indicative of a reflection of the outbound light pulse by a second object; detecting an overlap between electronic signals representing the first and second light pulses; and modeling, in response to detecting the overlap, the second light pulse based on a first piece of timing information in a given section of the second light pulse, wherein the given section of the second light pulse is outside of the overlap.

In another exemplary aspect, a light detection and ranging system is disclosed. The system includes a light emitter configured to emit an outbound light pulse and a light sensor configured to detect a first light signal indicative of a reflection of the outbound light pulse by an internal part of the system and generate a corresponding first electronic signal, and detect a second light signal indicative of a reflection of the outbound light pulse by a surrounding object and generate a corresponding second electronic signal. The second electronic signal includes a leading section and a trailing section. The system further includes a controller coupled to the light sensor that is configured to (1) detect an overlap between electronic signals representing the first and second light pulses, wherein the overlap causes a loss of a piece of timing information in a leading section of the second light pulse, (2) in response to the detection of the overlap, derive an estimated time value associated with the second light pulse based on a first piece of timing information in a trailing section of the second light pulse; and (3) determine a distance of the surrounding object from the LIDAR device based on the estimated time value associated with the second light pulse.

In yet another exemplary aspect, a light detection and ranging system is disclosed. The system includes a light emitter configured to emit an outbound light pulse and a light sensor configured to detect a first light signal indicative of a reflection of the outbound light pulse by a first object and generate a corresponding first electronic signal and detect a second light signal indicative of a reflection of the outbound light pulse by a second object and generate a corresponding second electronic signal. The system also includes a controller coupled to the light sensor, configured to (1) detect an overlap between electronic signals representing the first and second light pulses, and (2) in response to the detection of the overlap, model the second light pulse based on a first piece of timing information in a given section of the second light pulse, wherein the given section of the second light pulse is outside of the overlap.

The above and other aspects and their implementations are described in greater detail in the drawings, the description and the claims.

### BRIEF DESCRIPTION OF THE DRAWINGS

FIG. 1A is a schematic illustration of a representative system having a moveable object (e.g., an unmanned aerial vehicle) with a number of elements configured in accordance with one or more embodiments of the present technology.

FIG. 1B shows a schematic diagram of an exemplary LIDAR sensor system in accordance with various embodiments of the present disclosure.

FIG. 2A is a simplified diagram illustrating the basic working principle of a comparator-based sampling method.

FIG. 2B is an illustration of the input and output waveforms of the pulse signal before and after the comparator.

FIG. 3 illustrates a schematic diagram of a zero signal, an overlapped signal reflected by an object in a close area of the LIDAR system, and a regular signal reflected by an object outside of the blind spot area.

FIG. 4 illustrates a schematic diagram of a zero signal, two overlapped signals reflected by objects in a blind spot area of the LIDAR system, and two regular signals reflected by objects outside of the blind spot area.

FIG. 5 shows an example of timing error caused by widening of the pulse signal.

FIG. 6 is a schematic illustration of a comparator module with a multi-comparator configuration in accordance with an embodiment of the present technology.

FIG. 7 is an illustration of obtaining multiple sample points of pulse signals using a multi-comparator configuration.

FIG. 8 is a schematic illustration of a peak holding circuit in accordance with an embodiment of the present technology.

FIG. 9 is an illustration of obtaining multiple sample points of pulse signals using a multi-comparator configuration and a peak holding circuit.

FIG. 10 illustrates an example of partially overlapped signals where the overlapped area is below at least one of the multiple threshold voltage levels.

FIG. 11A shows an example of overlapping signals.

FIG. 11B shows another example of overlapping signals.

FIG. 11C shows yet another example of overlapping signals.

FIG. 12 is a flowchart representation of a method of signal processing for a LIDAR sensor system.

FIG. 13 is a flowchart representation of another method of signal processing for a LIDAR sensor system.

### DETAILED DESCRIPTION

As introduced above, it is important for unmanned vehicles to be able to independently detect obstacles and/or to automatically engage in evasive maneuvers. Light detection and ranging (LIDAR) is a reliable and accurate detection technology. Moreover, unlike traditional image sensors (e.g., cameras) that can only sense the surroundings in two dimensions, LIDAR can obtain three-dimensional information by detecting the depth. However, current LIDAR systems have their limits. For example, as is discussed in more detail below, many LIDAR systems include internal optical components that can reflect emitted light signals. The reflected signals from the internal components may interference with light signals reflected by surrounding objects that are located in proximity to the system. It is observed that many LIDAR systems are unable to accurately measure a surrounding object that is physically too close to the system due to such reflected signals from the internal components. Accordingly, there remains a need for improved techniques for implementing LIDAR systems so that LIDAR systems can accurately measure objects at a short distance away. The techniques disclosed herein allow a LIDAR system to recognize that a light signal is being interfered and, based on the recognition, to more accurately measure a surrounding object close by using additional data samples from the light signal.

In the following description, the example of a UAV is used, for illustrative purposes only, to explain various techniques that can be implemented using a LIDAR scanning module that is cheaper and lighter than the traditional LIDARs. In other embodiments the techniques introduced here are applicable to other suitable scanning modules, vehicles, or both. For example, even though one or more figures introduced in connection with the techniques illustrate a UAV, in other embodiments, the techniques are applicable in a similar manner to other type of movable objects including, but not limited to, an unmanned vehicle, a hand-held device, or a robot. In another example, even though the techniques are particularly applicable to laser beams produced by laser diodes in a LIDAR system, other types of light sources (e.g., other types of lasers, or light emitting diodes (LEDs)) can be applicable in other embodiments.

In the following, numerous specific details are set forth to provide a thorough understanding of the presently disclosed technology. In other embodiments, the techniques introduced here can be practiced without these specific details. In other instances, well-known features, such as specific fabrication techniques, are not described in detail in order to avoid unnecessarily obscuring the present disclosure. References in this description to “an embodiment,” “one embodiment,” or the like, mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics can be combined in any suitable manner in one or more embodiments. Also, it is to be understood that the various embodiments shown in the figures are merely illustrative representations and are not necessarily drawn to scale.

In this disclosure, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

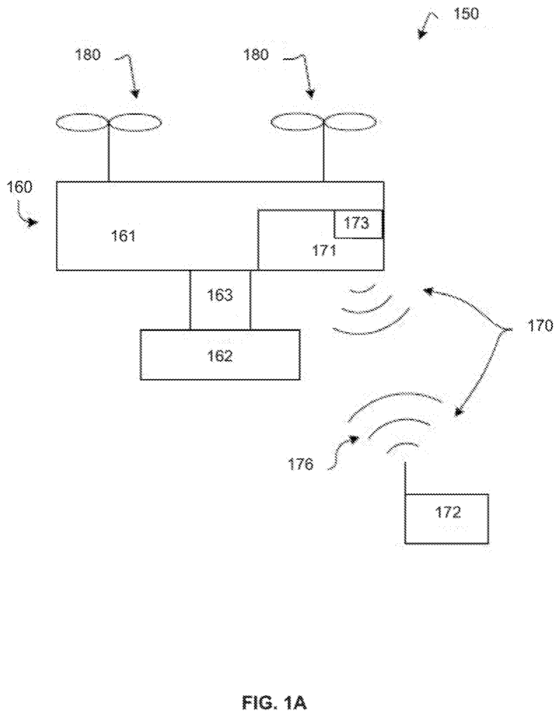

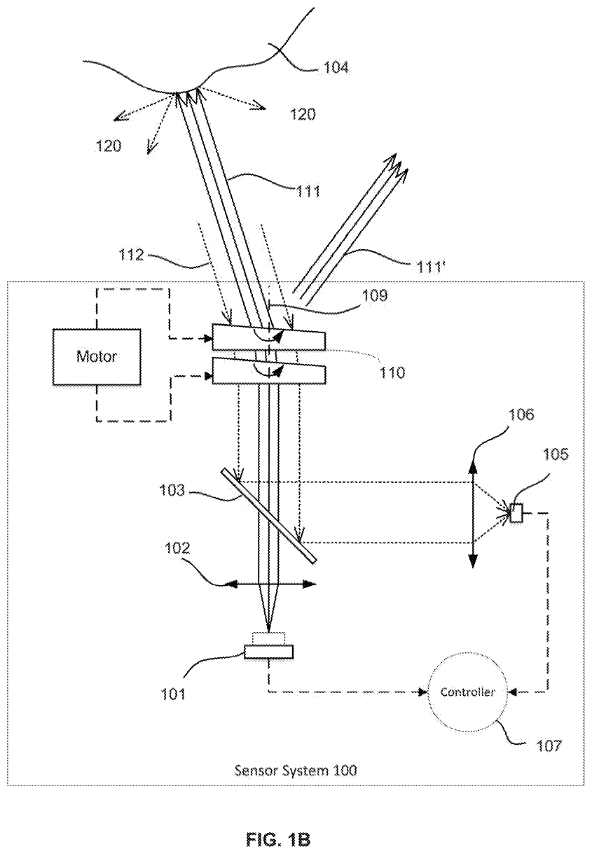

FIG. 1A is a schematic illustration of a representative system 150 having elements in accordance with one or more embodiments of the present technology. The system 150 includes a movable object 160 (e.g., an unmanned aerial vehicle) and a control system 170. The movable object 160 can be any suitable types of movable object that can be used in various embodiments.

The moveable object 160 can include a main body 161 (e.g., an airframe) that can carry a payload 162, for example, an imaging device or an optoelectronic scanning device (e.g., a LIDAR device). In some embodiments, the payload 162 can be a camera, a video camera and/or still camera. The camera can be sensitive to wavelengths in any of a variety of suitable bands, including visual, ultraviolet, infrared and/or other bands. The payload 162 can also include other types of sensors and/or other types of cargo (e.g., packages or other deliverables). In many of these embodiments, the payload 162 is supported relative to the main body 161 with a carrying mechanism 163. The carrying mechanism 163 can allow the payload 162 to be independently positioned relative to the main body 161. For instance, the carrying mechanism 163 can permit the payload 162 to rotate around one, two, three, or more axes. The carrying mechanism 163 can also permit the payload 162 to move linearly along one, two, three, or more axes. The axes for the rotational or translational movement may or may not be orthogonal to each other. In this way, when the payload 162 includes an imaging device, the imaging device can be moved relative to the main body 161 to photograph, video or track a target.

One or more propulsion units 180 can enable the movable object 160 to take off, land, hover, and move in the air with respect to up to three degrees of freedom of translation and up to three degrees of freedom of rotation. In some embodiments, the propulsion units 180 can include one or more rotors. The rotors can include one or more rotor blades coupled to a shaft. The rotor blades and shaft can be rotated by a suitable drive mechanism, such as a motor. Although the propulsion units 180 of the moveable object 160 are depicted as propeller-based and can have four rotors, any suitable number, type, and/or arrangement of propulsion units can be used. For example, the number of rotors can be one, two, three, four, five, or even more. The rotors can be oriented vertically, horizontally, or at any other suitable angle with respect to the moveable object 160. The angle of the rotors can be fixed or variable. The propulsion units 130 can be driven by any suitable motor, such as a DC motor (e.g., brushed or brushless) or an AC motor. In some embodiments, the motor can be configured to mount and drive a rotor blade.

The movable object 160 is configured to receive control commands from the control system 170. In the embodiment shown in FIG. 1A, the control system 170 includes some components carried on the moveable object 160 and some components positioned off the moveable object 160. For example, the control system 170 can include a first controller 171 carried by the moveable object 110 and a second controller 172 (e.g., a human-operated, remote controller) positioned remote from the moveable object 160 and connected via a communication link 176 (e.g., a wireless link such as a radio frequency (RF) based link). The first controller 171 can include a computer-readable medium 173 that executes instructions directing the actions of the moveable object 160, including, but not limited to, operation of the propulsion system 180 and the payload 162 (e.g., a camera). The second controller 172 can include one or more input/output devices, e.g., a display and control buttons. The operator manipulates the second controller 172 to control the moveable object 160 remotely, and receives feedback from the moveable object 160 via the display and/or other interfaces on the second controller 172. In other representative embodiments, the moveable object 160 can operate autonomously, in which case the second controller 172 can be eliminated, or can be used solely for operator override functions.

FIG. 1B shows a schematic diagram of an exemplary LIDAR sensor system in accordance with various embodiments of the disclosed technology. For example, a LIDAR sensor system 100 can detect the distance of the object 104 based on measuring the time for light to travel between the LIDAR sensor system 100 and the object 104, i.e., the time-of-flight (TOF). The sensor system 100 includes a light emitter 101 that can generate a laser beam. The laser beam can be a single laser pulse or a series of laser pulses. A lens 102 can be used for collimating the laser beam generated by the light emitter 101. The collimated light can be directed toward a beam splitting device 103. The beam splitting device 103 can allow the collimated light from the light source 101 to pass through. Alternatively, the beam splitting device 103 may not be necessary when different schemes are employed (e.g., when a light emitter is positioned in front of the detector).

The sensor system 110 also includes a beam steering device 110 that comprises various optical elements such as prisms, mirrors, gratings, optical phase array (e.g., liquid crystal controlled grating). These different optical elements can rotate about a common axis 109 in order to steer the light toward different directions, such as direction 111 and 111′. When the outgoing beam 111 hits the object 104, the reflected or scattered light may spread over a large angle 120 and only a fraction of the energy may be reflected back toward the sensor system 100. The return beam 112 can be reflected by the beam splitting device 103 toward a receiving lens 106, which can collect and focus the returned beam on a detector 105.

The detector 105 receives the returned light and converts the light into electrical signals. Also, a controller including a measuring circuitry, such as a time-of-flight (TOF) unit 107, can be used for measuring the TOF in order for detecting the distance to the object 104. Thus, the sensor system 100 can measure the distance to the object 104 based on the time difference between the generating of the light pulse 111 by the light source 101 and the receiving of the return beam 112 by the detector 105.

In order to successfully capture a very short pulse signal (e.g., with a pulse duration of only tens of nanoseconds to a few nanoseconds), many LIDAR systems rely on high-speed analog-to-digital converters (ADCs) (e.g., with a sampling rate that exceeds one Giga sample per second (GSPS)) to perform the digitization of light pulse signals. High-speed ADCs typically are of high cost and high power consumption. Furthermore, high-speed ADC sampling is based on sampling analog signals with different voltages at the same time interval (i.e., sampling with respect to the time axis). As such, the timing of the sampling is independent from the pulse signal and without any time correlation. An extraction algorithm is needed to extract the timing information of the analog signal.

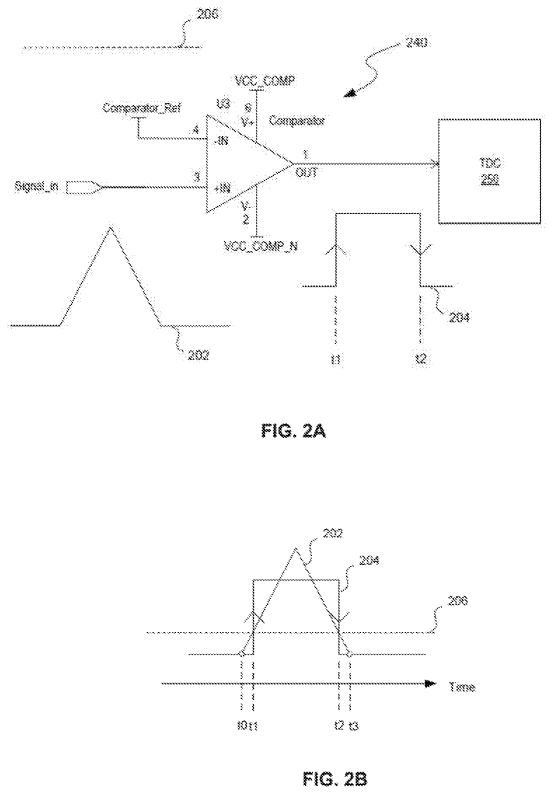

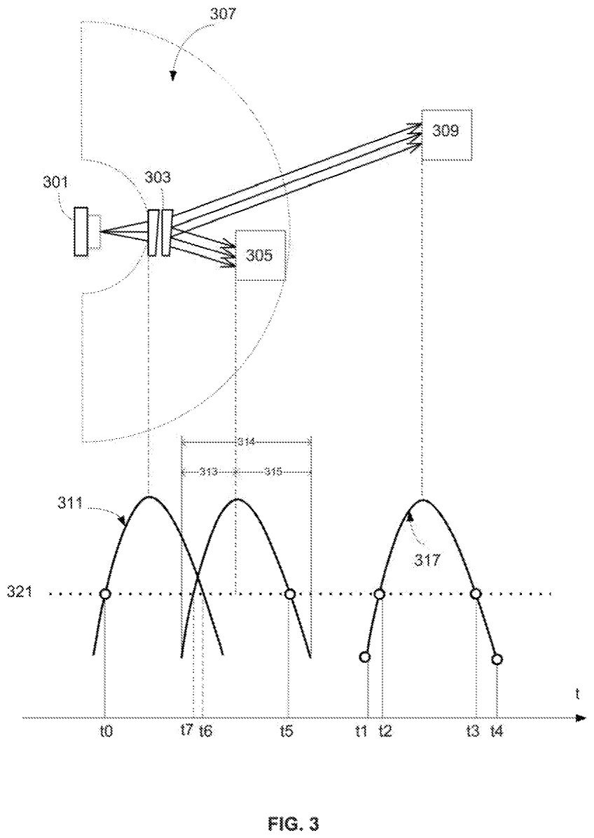

An alternative solution is to utilize comparator-based sampling in the LIDAR system for gathering the timing information of the reflected pulse signal. FIG. 2A is a simplified diagram illustrating the basic working principle of a comparator-based sampling method. The method is based on the timing of when the analog signal crosses certain thresholds (also referred to herein as a “reference threshold” or a “triggering threshold”). As shown in the example of FIG. 2A, a comparator 240 is basically an operational amplifier that is configured to compare the voltage between its non-inverting input (PIN3) against its inverting input (PIN4), and to output a logic high or low voltage based on the comparison. For example, when an analog pulse signal 202 (e.g., that is reflected back from a target object) is received at the non-inverting input PIN3, the comparator 240 compares the voltage level of the signal 202 against a reference threshold 206 at the inverting input PIN4. The signal 202 has two sections: a leading section in which the magnitude increases, and a trailing section in which the magnitude decreases. When the magnitude in the leading section of signal 202 exceeds the reference threshold 206, the output of the comparator 202 becomes high (e.g., VDD). Similarly, when the magnitude in the trailing section of signal drops below the reference threshold 206, the output of the comparator 202 becomes low (e.g., GND). The result is a digitized (e.g., binary), square pulse signal 204. FIG. 2B is an illustration of the input and output waveforms of the pulse signal before and after the comparator. When the square pulse signal 204 is output to a time-to-digital converter (TDC) 250, relevant timing information of the signal 204 (e.g., time t1 and time t2) can be extracted. Because there is a correlation between the sampling points and time (in contrast to the ADC based method), the high-speed comparator method can more effectively capture pulse information in a more direct manner.

Regardless of whether the LIDAR system employs an ADC-based or a comparator-based sampling mechanism, there exists a limitation in LIDAR that prevents LIDAR from accurately measuring a surrounding object that is in close physical proximity to the LIDAR system. Specifically, due to the internal structures of the LIDAR sensor system, such as the beam splitting device 103 or the beam steering device 110 shown in FIG. 1B, the detector 105 of the LIDAR sensor system may first detect a pulse signal reflected by an internal component when the light exits the LIDAR (i.e., before the light can hit the surrounding object and be reflected back from the surround object to the LIDAR detector). This internally-reflected pulse signal usually has stable presence (i.e., not varying a lot with the LIDAR's surrounding environment) and is also referred to herein as “the zero signal.” If a surrounding object is located close enough to the LIDAR sensor system, the pulse signal reflected from the surrounding object may overlap the zero signal, causing difficulties in obtaining timing information of the pulse signal. This issue can also be referred to as the blind spot area problem. The blind spot area problem may adversely affect LIDAR sensor systems using either high-speed ADCs or low-cost comparators. For simplicity, this disclosure uses comparator-based LIDAR sensor systems as examples when describing techniques that address this issue. However, the disclosed techniques can also be applied to high-speed ADC type of LIDAR sensor systems (e.g., sampling at multiple time intervals), or LIDAR sensor systems using other sampling mechanisms.

FIG. 3 illustrates a schematic diagram of signals detected by the LIDAR system, namely, a zero signal 311, an overlapped signal 314 reflected by an object in a close area (also referred to as “the blind spot area”) of the LIDAR system, and a regular signal 317 reflected by an object outside of the blind spot area. Specifically, the signal 314 can be broken down into two sections, a leading section and a trailing section. The leading section of the signal 314 is referred to herein as the leading section 313, and the trailing section of the signal 314 is referred to herein as the trailing section 315. In this particular example shown in FIG. 3, a beam steering device 303, in addition to its intended function of steering the beam of light from the emitter 301, nonetheless reflects a portion of the beam of light. The detector (not shown) detects this pulse signal reflected by the LIDAR system's internal component (e.g., the beam steering device 303) as the zero signal 311. Because this signal is caused by the internal structure of the LIDAR system, its parameters (e.g., magnitude, or width) are largely fixed and can be learnt in advance (e.g., during a calibration phase). The controller of the LIDAR sensor system can obtain and store the relevant timing information of the zero signal (e.g., t0 and t6) when there is no object in proximity to the system. The knowledge of the relevant timing information of the zero signal helps the controller determine whether other reflected signals overlap this zero signal. For example, when the comparator fails to identify when the magnitude of the zero signal drops below the triggering threshold 321 (e.g., at t6), the controller knows that there is another reflected signal that is being interfered by the zero signal.

In this example shown in FIG. 3, an object 309 is located at a normal distance (i.e., outside the blind spot area 307) from the LIDAR sensor system. The detector detects the pulse signal 317 reflected by the object 309. Based on the threshold voltage level 321 used by the LIDAR sensor system, timing information can be gathered from both the leading and trailing sections of the pulse signal 317. For example, when the signal magnitude exceeds or drops below the threshold voltage level 321, timing information t2 and t3 can be obtained by the comparator illustrated in FIG. 2A. Moreover, the controller can estimate the start and end time (e.g., t1 and t4) of the pulse signal based on t2 and t3. The controller of the LIDAR sensor system can use these samples (e.g., t1, t2, t3 and t4) to fit the pulse signal to a predetermined signal model, or compare the timing information of the pulse signal to pre-existing statistical data stored on a database or look-up table, to determine how far the object 309 is from the LIDAR sensor system.

FIG. 3 also shows an object 305 that is located very close to the LIDAR system (i.e., inside the blind spot area 307). The detector is supposed to detect the pulse signal 314 reflected by the object 307. The trailing section 315 of the its reflected pulse signal remains unaffected by the zero signal 311, and timing information t5 remains obtainable and is captured. However, the leading section 313 of the reflected pulse signal partially overlaps the zero signal 311 because the object 305 is very close to the LIDAR system. The signals in the overlapped area interfere with each other because the trailing section of the signal 311 is still above the triggering threshold 321, which makes it difficult for the comparator to determine the timing of when signal magnitude in the leading section 313 exceeds the threshold voltage level 321. Therefore, the timing information t7 carried in the leading section 313 of the pulse signal is unmeasurable and becomes lost. Because the controller now has only partial timing information of the pulse signal (e.g., t5), it cannot accurately determine the distance from the object 305 to the LIDAR sensor system. The overlapping of the leading section 313 of the pulse signal with the zero signal 311 leads to a blind spot area 307 within which the determination of object positions becomes less accurate as compared to a signal (e.g., signal 317) where more than one piece of timing information about the signal may be obtained.

Furthermore, it is noted that the actual shape of the pulse signal in the reflected light will be subject to a number of environmental factors, such as the noise (e.g., ambient light noise and/or electronic noise, discussed below), the distance of the target object, the surface and color of the target object, and so forth. It has been observed that surface properties of the objects can have a large impact on the magnitude of the pulse signals and affect the accuracy of the timing information.

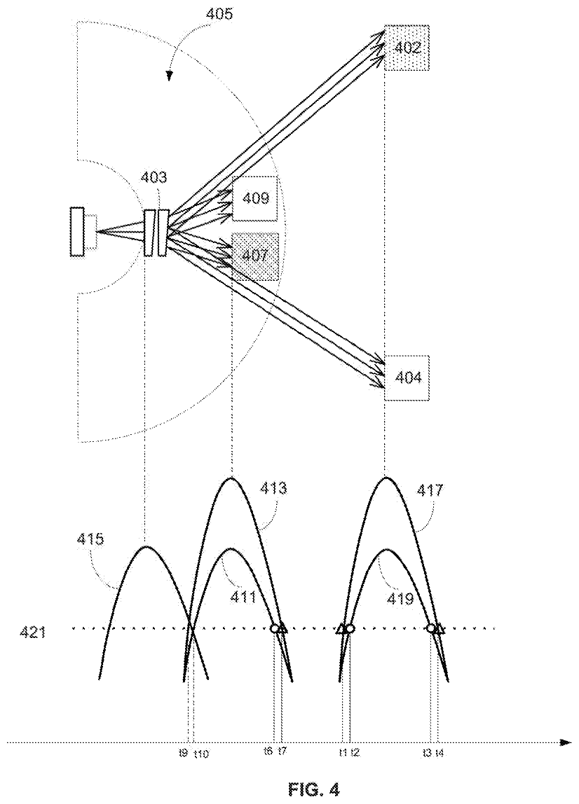

FIG. 4 illustrates a schematic diagram of a zero signal 415, two overlapped signals reflected by objects in a blind spot area of the LIDAR system 411 and 413, and two regular signals reflected by objects outside of the blind spot area 417 and 419. In this example, the beam steering device 403 reflects a pulse signal 415 as the zero signal. Both objects 402 and 404 are located outside of the blind spot area 405 and at the same distance from the LIDAR sensor system. The detector detects two reflected pulse signals 417 and 419. Although the objects 402 and 404 are at the same distance from the LIDAR sensor system, their different surface properties result in different magnitudes in the reflected pulse signals. For example, object 402 has a darker surface color, leading to pulse signal 419 with a smaller magnitude. On the other hand, object 404 has a lighter surface color, leading to pulse signal 417 with a larger magnitude. The difference in magnitudes may cause a timing difference when the signal crosses the triggering threshold 421 (e.g., t1 versus t2), leading the controller to erroneously conclude that object 404 is located at a different distance from object 402. However, because timing information in both the leading and trailing sections are available, the controller can take t3 and t4 into consideration. The additional timing information from the trailing section allows the controller to account for different magnitudes of the signals in order to make a more accurate determination of the object locations, either based on a pulse signal model or statistical search using the timing information.

FIG. 4 also shows two objects, 407 and 409, that are located in a blind spot area 405 and at the same distance from the LIDAR sensor system. The leading sections of the respective pulse signal 411 and 413 overlap the zero signal 415. The pulse signals 411 and 413 have different magnitudes due to different surface properties of object 407 and 409. For example, object 407 has a darker surface color, resulting in pulse signal 411 with a smaller magnitude. Object 409, on the other hand, has a lighter surface color, resulting in pulse signal 413 with a larger magnitude. The controller of the LIDAR sensor system obtains different timing information from the trailing sections of signal 411 and 413 at threshold voltage level 421. For example, the controller obtains t6 as relevant timing information for signal 411, and t7 as relevant timing information for signal 413. However, the timing information carried in the leading sections of signals 411 and 413 (e.g., t9 and t10) is lost because the comparator is not able to determine when the signal magnitudes in the leading sections of signals 411 and 413 exceed the threshold voltage level 412. The difference in timing information (e.g., t6 versus t7) can lead the controller to erroneously determine that object 407 and object 409 are located at two different distances from the LIDAR sensor system. In this case, because the controller only has timing information from the trailing sections of the signals, it can be difficult for it to correct the timing error and determine accurate locations for the objects 407 and 409.

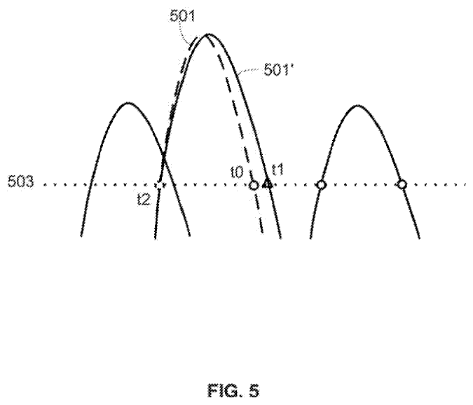

Other types of timing errors can be caused by the internal circuitry of the LIDAR sensor system. For example, a pulse signal with a large magnitude may be extended and/or widened after the pulse signal being processed by some of the internal amplification circuits of the LIDAR system. FIG. 5 shows an example of timing error caused by a widening of the pulse signal. In this example, signal 501 has a large magnitude. After the operation of the internal circuitry (e.g., by an amplifier), or from the impedance of the internal circuitry of the LIDAR sensor system, signal 501 may be widened and become 501′. The corresponding timing information changes from t0 to t1, leading to a timing error. Because the timing information in the leading section (e.g., t2) is lost due to the signal overlap, it can be difficult for the controller to correct this error without further information from the pulse signal 501′.

To address the inaccuracy of object measurement caused by loss of information in the leading sections of the reflected signals, embodiments of the LIDAR sensor system disclosed here can increase the effective sampling rate of the signals to obtain more data. In particular, the LIDAR sensor system can obtain multiple samples in sections outside of the overlapped area (e.g., in the trailing section) of a pulse signal in order to determine the shape of the pulse signal and/or relevant timing information of the signal.

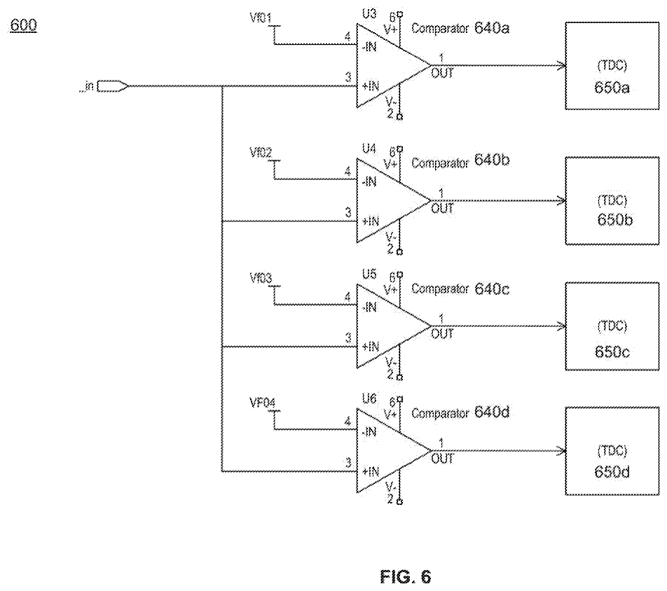

For example, in a comparator-based LIDAR sensor system, multiple comparators can be used to obtain more samples from the trailing section of the signal. FIG. 6 is a schematic illustration of a comparator module with a multi-comparator configuration in accordance with embodiments of the present technology. The multi-comparator configuration includes two or more comparators, each of the comparators are coupled to the same input to perform timing measurement on the same light pulse, but each of the comparators has a different triggering threshold. In this example, the comparator module 600 includes a total of four comparators, 640a-640d. Each of the comparator is connected to its respective individual time-to-digital converter (TDC), 650a-650d. Additionally, each of the comparator receives a different triggering threshold. As illustrated, the comparator 640a receives its individual triggering threshold Vf01, the comparator 640b receives Vf02, the comparator 640c receives Vf03, and the comparator 640d receives Vf04.

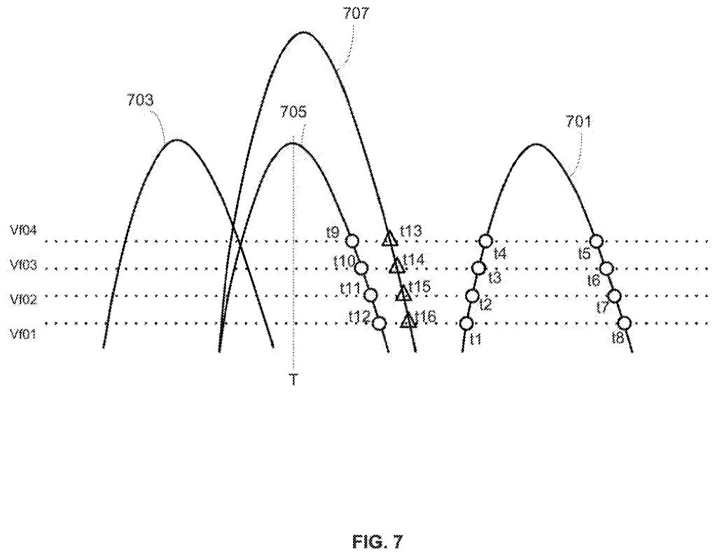

FIG. 7 is an illustration of obtaining multiple sample points of pulse signals using a multi-comparator configuration. In this particular example, eight samples of timing information (e.g., t1-t8) can be obtained at four different threshold levels (e.g., Vf01-Vf04) for a regular pulse signal 701. For signals that partially overlap the zero signal 703, four samples in the trailing section can be obtained using the multi-comparator configuration. For example, the controller, after obtaining four data samples (t9, Vf04), (t10, Vf03), (t11, Vf02), and (t12, Vf01) for signal 705, can fit the multiple samples to one or more pulse signal models, or compare the timing information of the pulse signal to pre-existing statistical data stored on a database or look-up table, to determine the distance of the corresponding object from the LIDAR system.

In some implementations, the controller may fit the data samples to an analytical model such as a polynomial or a triangular model. Then, the controller can derive an estimated time value (e.g., time value T as illustrated in FIG. 7) based on the shape of the analytical model. For example, the controller can choose the time value T by examining when the signal magnitude reaches its maximum. In some embodiments, the controller may use other criteria, such as the width of the signal in a square signal model, to derive the estimated time value associated with the pulse signal for TOF computation in order to determine the distance of the corresponding object from the LIDAR system.

In some implementations, the controller may search in a database or a look-up table to find a set of values that is the closest match to the data samples. The set of values may have the form of (tᵢ, Vfᵢ), where Vfᵢ correspond to the threshold levels. The set of values can map to an output time value, or an output tuple in the form of (T, V), that is stored in the database or look-up table. V may correspond to one of the threshold levels. In some embodiments, V may be a predetermined signal magnitude different from the threshold levels. The controller then can select the mapped output time value, or T from the mapped output tuple corresponding to V, to facilitate the computation of TOF in order to determine the distance of the corresponding object from the LIDAR system.

Similarly, the controller can perform the same tasks for four data samples (t13, vf04), (t14, vf03), (t15, vf02), and (t16, vf01) to obtain a more accurate model or statistical values for the pulse signal, thereby minimizing the impact of signal magnitude and/or widening of the signal on the accuracy of object measurement.

In some embodiments, the controller can deduce the pulse signal magnitude from multiple data samples of the timing information. For example, after fitting samples (t13, vf04), (t14, vf03), (t15, vf02), and (t16, vf01) to a signal model (e.g. a parabola model), the controller can estimate the magnitude of the signal. In some embodiments, however, because the samples are limited to the trailing section of the pulse signal, the estimation of the signal magnitude may be less accurate (for the reasons described above). It is thus desirable to separately measure the magnitude of the signal to provide more information.

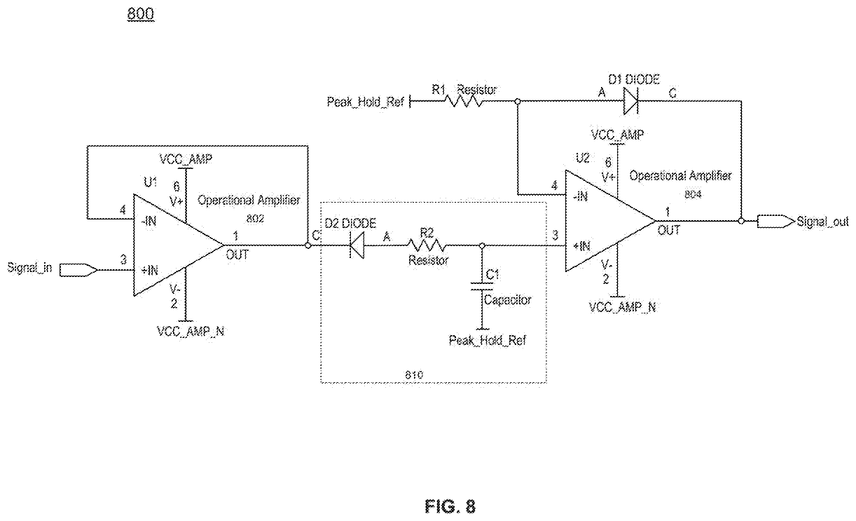

FIG. 8 is a schematic illustration of a peak holding circuit in accordance with embodiments of the present technology that can detect the magnitude of the pulse signals. The peak holding circuit 800 includes a peak holding core 810, which includes a diode D2, a resistor R2, and a capacitor C1. The peak holding circuit 800 also includes a first operational amplifier 802, and a second operational amplifier 804. In some embodiments, the first operational amplifier 802 receives signal and passes the signal to the peak holding core 810, which in turn passes to the second operational amplifier 804.

Such peak holding circuit 800 is advantageous over conventional peak holding circuits in its ability to capture the peak information for a very short pulse signal (e.g., tens nanoseconds to a few nanoseconds) and its ability to continuously capture the peak information without needing a relatively long recovery time (e.g., 20 to 30 nanoseconds). In some variations, depending on the design of the entire circuitry of the LIDAR system, the first operational amplifier 802 may be omitted. In some of embodiments that are to hold the peak values for negative amplitude signals, the reference signal can be slightly larger than the steady state voltage of the system to reduce the measuring dead zone caused by the voltage drop from the diode D2. Similarly, in some of embodiments that are to hold the peak values for positive amplitude signals, the reference signal can be slightly smaller than the steady state voltage of the system to reduce the measuring dead zone caused by the voltage drop from the diode D2.

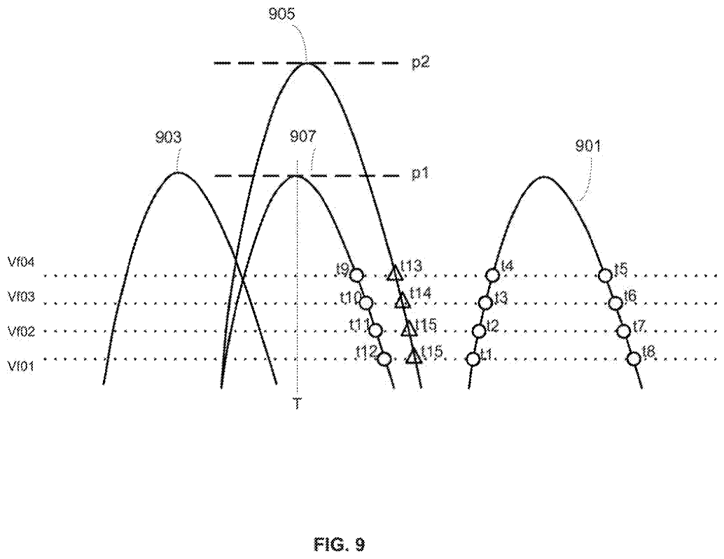

FIG. 9 is an illustration of obtaining multiple sample points of pulse signals using a multi-comparator configuration and a peak holding circuit. In this particular example, similar to the example shown in FIG. 7, eight samples of timing information (e.g., t1-t8) can be obtained for four different threshold levels (e.g., Vf01-Vf04) for a regular pulse signal 901. For signals that partially overlap the zero signal 903, four samples in the trailing section can be obtained using the multi-comparator configuration. In addition, the magnitude of the pulse signal can be obtained using the peak holding circuit. For example, the controller, after obtaining five data samples (t9, vf04), (t10, vf03), (t11, vf02), (t12, vf01), and p1 for signal 907, can fit the multiple samples to a pulse signal model, or compare the samples of the pulse signal to pre-existing statistical data stored on a database or look-up table, to determine the distance of the corresponding object from the LIDAR system.

In some implementations, the controller may fit the data samples to an analytical model such as a polynomial or a triangular model. The controller can derive an estimated time value T based on the shape of the analytical model. For example, the controller can choose the time value T by examining when the signal magnitude reaches the value obtained by the peak holding circuit. In some embodiments, the controller may use other criteria, such as the width of the signal in a square signal model, to derive the estimated time value associated with the pulse signal for TOF computation in order to determine the distance of the corresponding object from the LIDAR system.

In some implementations, the controller may search in a database or a look-up table to find a set of values that is the closest match to the data samples. The set of values may have the form of (tᵢ, Vfᵢ), where Vfᵢ correspond to the threshold levels. The set of values can map to an output time value, or an output tuple in the form of (T, V), that is stored in the database or look-up table. The V may correspond to one of the threshold levels. In some embodiments, V may be a predetermined signal magnitude different from the threshold levels. The controller then select the mapped output time value, or T from the mapped output tuple corresponding to V, to facilitate the computation of TOF in order to determine the distance of the corresponding object from the LIDAR system.

The controller can perform the same tasks for five data samples (t13, vf04), (t14, vf03), (t15, vf02), (t16, vf01), and p2 to obtain a more accurate model or statistical values for the pulse signal 905, thereby minimizing the impact of signal magnitude and/or widening of the signal on the accuracy of object measurement.

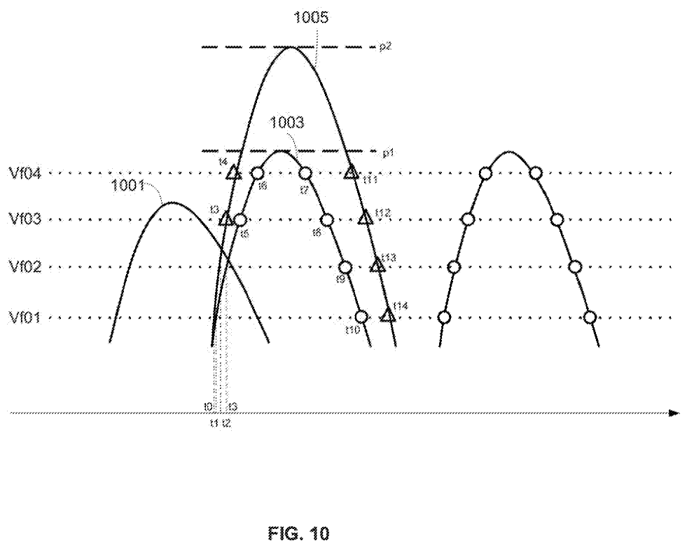

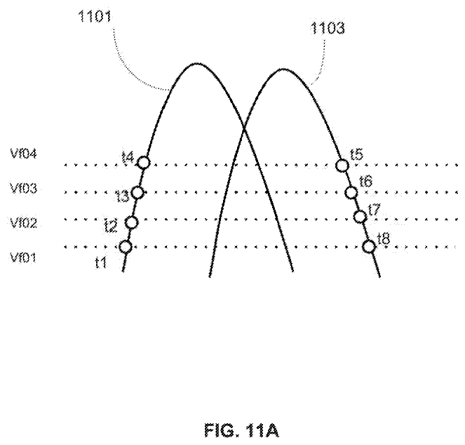

In some cases, even though an object is located within the blind spot area of the LIDAR sensor system, the leading section of the reflected pulse signal may still contain valid timing information. For example, FIG. 10 illustrates an example of partially overlapped signals where the overlapped area does not affect the comparators at one or more of the multiple threshold voltage levels. In this example, the zero signal 1001 has a relatively small magnitude. Therefore, while it is difficult for the comparators to discern when signal magnitudes of signal 1003 and 1005 exceed threshold levels Vf01 and Vf02, leading to a loss of timing information of t0-t1 and t2-t3, the comparators are still able to obtain timing information carried in the remaining of the leading section of signals 1003 and 1005 for threshold voltage levels Vf03 and Vf04, such as t3, t4, t5, and t6.

The controller, therefore, can add the additional timing information (e.g., t5 t6) from the leading section to the data samples in the trailing section (e.g. t7, t8, t9, and t10), as well as the magnitude (e.g., p1), for signal 1003. It can fit the multiple samples to a pulse signal model, or compare such information to pre-existing statistical data stored on a database or look-up table, to determine the distance of the corresponding object from the LIDAR system. Similarly, the controller can add the additional timing information (e.g., t3 and t4) from the leading section to the data samples in the trailing section (e.g. t11, t12, t13, and t14), as well as the magnitude (e.g., p2), for signal 1005 to obtain a more accurate model or statistical values for the pulse signal, thereby minimizing the impact of signal magnitude and widening of the signal on the accuracy of object detection.

The specific configuration described above are made to illustrate examples of handling signal overlapping with the zero signal. It is however understood that the same techniques can be applied generally to other types of signal overlapping scenarios. For example, the first signal is not limited to the zero signal and can be a pulse signal reflected from another surrounding object.

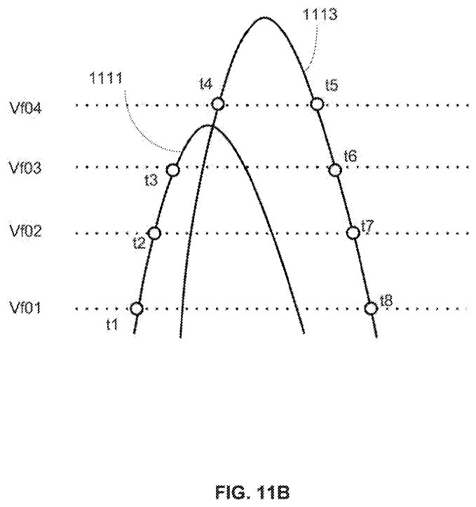

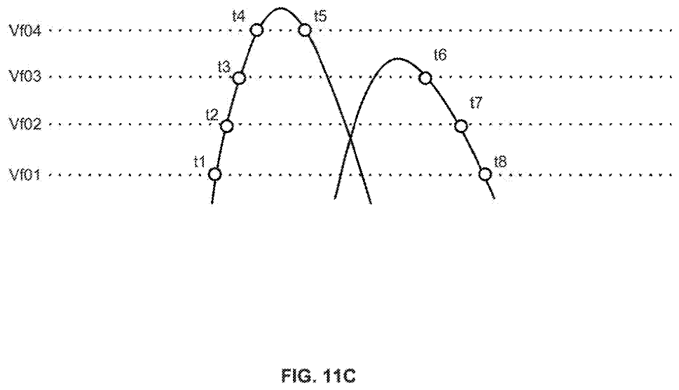

Based on the obtained timing information using the techniques disclosed herein, the controller can model the pulse signals using an analytical model, e.g., a triangular or parabolic model. In some embodiments, the controller can also model the pulse signals using one or more different models, for different pulse signals or for the same pulse signal. FIGS. 11A-C shows various examples of overlapped signals. In these examples, the obtained timing information comes from both the interfering signal (e.g., the zero signal) and the target signal. Because the timing information does not correlate directly to the target signal, it is desirable to establish multiple sub-models in different time intervals to more accurately describe the target signal, as well as the interfering signal.

For example, in FIG. 11A, the controller obtains four timing samples (e.g. t1-t4) for the first pulse signal 1101. The controller cannot obtain accurate timing information in the overlapped area because the signals interfere with each other, making it difficult for the comparators to ascertain when signal magnitudes exceed or drop below the relevant threshold levels. The controller obtains four timing samples (e.g., t5-t8) in the trailing section of the second pulse signal 1103 (i.e., the target signal). Because the timing samples come from two separate pulse signals, it is desirable to model them separately using two simple sub-models in different time intervals.

FIG. 11B shows another example of overlapping signals. The controller obtains four timing samples (e.g. t1-t3) for the first pulse signal 1111 because the magnitude of the pulse signal 1111 is relatively small. The controller cannot obtain accurate timing information in the overlapped area because the signals interfere with each other, making it difficult for the comparators to ascertain when signal magnitudes exceed the relevant threshold levels. However, because the magnitude of the second pulse signal 1113 (i.e., the target signal) is relatively large, the controller obtains five timing samples (e.g., t4-t8) in both the leading and trailing sections of the pulse signal 1113. Because the timing samples come from two separate pulse signals, it can be a complex task to fit them into one model. Therefore, it is also desirable to model them separately using two sub-models in different time intervals.

FIG. 11C shows yet another example of overlapping signals. In this example, the controller obtains five timing samples (e.g. t1-t5) for the first pulse signal 1121 in both leading and trailing sections. Again, the controller cannot obtain accurate timing information in the overlapped area because the signals interfere with each other, making it difficult for the comparators to ascertain when the magnitude of the pulse signal exceeds the threshold levels. The controller then obtains three timing samples (e.g., t6-t8) for the second pulse signal 1123 (i.e., the target signal). Because the timing samples come from two separate pulse signals and form a complex shape, it is again desirable to model them separately using two simple sub-models in different time intervals.

The eight samples obtained in the above scenarios can be taken as one set of input X={t1, . . . , t8} to fit function:

ƒ(X)=Σᵢ₌₁⁸Σⱼ₌₁⁸(αᵢⱼ*tᵢ*tⱼ+bᵢ*tᵢ+cᵢ) Eq. (1)

The controller then determines aᵢⱼ, bᵢ, and cᵢ for the function to describe the pulse signal. In some cases, such as the examples shown in FIGS. 11A-C, input X is collected from separate signals and does not correlate well to a simple model. Therefore, it is desirable to divide the input into two or more sets. For example, in the case shown in FIG. 11A, two sets X1={t1, . . . , t4} and X2={t5, . . . , t8} can be used to establish two separate models. In the case shown in FIG. 11B, two sets X1={t1, t2, t3} and X2={t4, . . . , t8} can be used to obtain two different models. Similarly, in the case depicted in FIG. 11C, the input can be divided into X1={t1, . . . , t5} and X2={t6, t7, t8} to obtain two simple models for the pulse signals. After the controller obtains simple models for the pulse signals, it can proceed to derive an estimated time value for each of the pulse signals that represents the time when the pulse signal is received. The estimated time value then can be used to facilitate computation of TOF to determine the distance of the corresponding object from the LIDAR sensor system.

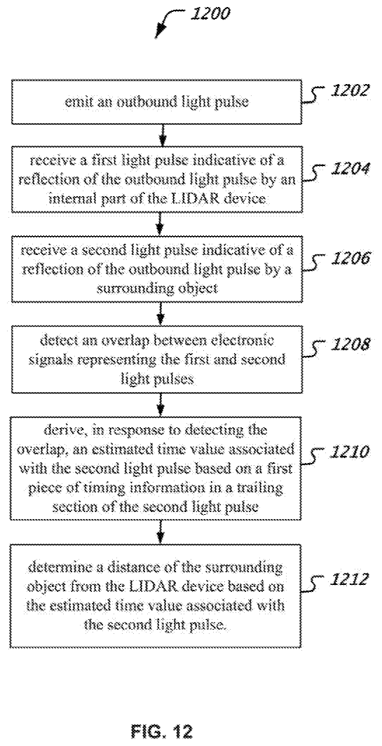

FIG. 12 is a flowchart representation of a method of signal processing for a LIDAR sensor system. The method 1200 includes, at 1202, emitting, by a light detection and ranging (LIDAR) device, an outbound light pulse; at 1204, receiving, at the LIDAR device, a first light pulse indicative of a reflection of the outbound light pulse by an internal part of the LIDAR device; at 1206, receiving, at the LIDAR device, a second light pulse indicative of a reflection of the outbound light pulse by a surrounding object; at 1208, detecting an overlap between electronic signals representing the first and second light pulses, wherein the overlap causes a loss of a piece of timing information in a leading section of the second light pulse; at 1210, deriving, in response to detecting the overlap, an estimated time value associated with the second light pulse based on a first piece of timing information in a trailing section of the second light pulse; and, at 1212, determining a distance of the surrounding object from the LIDAR device based on the estimated time value associated with the second light pulse.

In some embodiments, the estimated time value is derived without the lost piece of timing information in the leading section of the second light pulse. The first piece of timing information in the trailing section of the second light pulse corresponds to a first triggering threshold. In some embodiments, the deriving of the estimated time value associated with the second light pulse is further based on a second piece of timing information in the trailing section of the second light pulse. The second piece of timing information in the trailing section of the second light pulse corresponds to a second trigger threshold that is different from the first triggering threshold.

In some embodiments, the deriving of the estimated time value associated with the second light pulse is further based on a peak information of the second light pulse. The estimated time value associated with the second light pulse can be derived further based on an obtainable piece of timing information in the leading section of the second light pulse not affected by the overlap.

In some embodiments, the deriving of the estimated time value associated with the second light pulse is based on (1) a second piece of timing information in the trailing section of the second light pulse and (2) a peak information of the second light pulse. The deriving of the estimated time value associated with the second light pulse may be further based on an obtainable piece of timing information in the leading section of the second light pulse not affected by the overlap.

In some embodiments, the method further includes determining a piece of timing information in a trailing section of the first light pulse. The overlap is detected based on the piece of timing information in the trailing section of the first light pulse.

In some embodiments, the deriving of the estimated time value associated with the second light pulse is based on fitting data including the first piece of timing information in the trailing section of the second light pulse to an analytical model. The deriving of the estimated time value associated with the second light pulse can be based on a shape of the analytical model.

In some embodiments, the estimated time value associated with the second light pulse corresponds to a predetermined signal magnitude. The predetermined signal magnitude is stored in a database or lookup table.

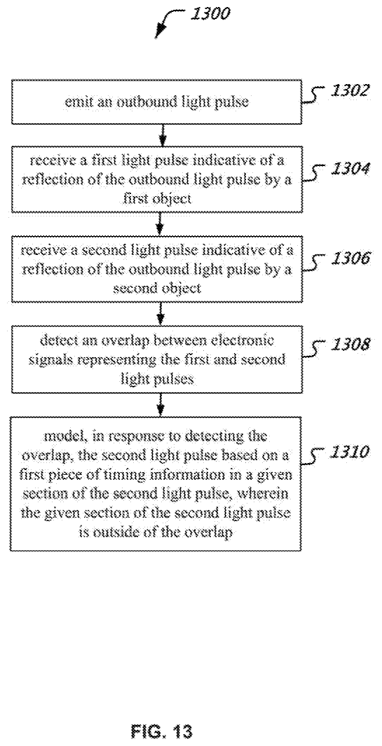

FIG. 13 is a flowchart representation of another method of signal processing for a LIDAR sensor system. The method 1300 includes, at 1302, emitting, by a light detection and ranging (LIDAR) device, an outbound light pulse; at 1304, receiving, at the LIDAR device, a first light pulse indicative of a reflection of the outbound light pulse by a first object; at 1306, receiving, at the LIDAR device, a second light pulse indicative of a reflection of the outbound light pulse by a second object; at 1308, detecting an overlap between electronic signals representing the first and second light pulses; and, at 1310, modeling, in response to detecting the overlap, the second light pulse based on a first piece of timing information in a given section of the second light pulse, wherein the given section of the second light pulse is outside of the overlap.

In some embodiments, the given section of the second light pulse is a second half of the second light pulse. The first piece of timing information in the given section of the second light pulse corresponds to a first triggering threshold.

In some embodiments, the second light pulse is modeled further based on a second piece of timing information in the given section of the second light pulse. The second piece of timing information corresponds to a second triggering threshold that is different from the first triggering threshold.

In some embodiments, the method further includes modeling, in response to detecting the overlap, the first light pulse based on a first piece of timing information in a given section of the first light pulse, wherein the given section of the first light pulse is outside of the overlap. The given section of the first light pulse can be a first half of the first light pulse. The first piece of timing information in the given section of the first light pulse corresponds to a first triggering threshold.

In some embodiments, the first light pulse is modeled further based on a second piece of timing information in the given section of the first light pulse, the second piece of timing information corresponding to a second triggering threshold that is different from the first triggering threshold. The first light pulse can be modeled using a first model and the second light pulse is modeled using a second model that is different from the first model.

It is thus evident that, in one exemplary aspect, a light detection and ranging system is provided that includes a light emitter configured to emit an outbound light pulse, and a light sensor configured to detect a first light signal indicative of a reflection of the outbound light pulse by an internal part of the system and generate a corresponding first electronic signal and detect a second light signal indicative of a reflection of the outbound light pulse by a surrounding object and generate a corresponding second electronic signal. The second electronic signal includes a leading section and a trailing section. The system also includes a controller coupled to the light sensor that is configured to (1) detect an overlap between electronic signals representing the first and second light pulses, wherein the overlap causes a loss of a piece of timing information in a leading section of the second light pulse, (2) in response to the detection of the overlap, derive an estimated time value associated with the second light pulse based on a first piece of timing information in a trailing section of the second light pulse; and (3) determine a distance of the surrounding object from the LIDAR device based on the estimated time value associated with the second light pulse.

In some embodiments, the controller is configured to derive the estimated time value associated with the second light pulse without the lost piece of timing information in the leading section of the second light pulse. The first piece of timing information in the trailing section of the second light pulse corresponds to a first triggering threshold.

In some embodiments, the controller is configured to derive the estimated time value associated with the second light pulse further based on a second piece of timing information in the trailing section of the second light pulse. The second piece of timing information in the trailing section of the second light pulse corresponds to a second trigger threshold that is different from the first triggering threshold.

In some embodiments, the controller is configured to derive the estimated time value associated with the second light pulse is further based on a peak information of the second light pulse. The controller may be configured to derive the estimated time value associated with the second light pulse further based on an obtainable piece of timing information in the leading section of the second light pulse not affected by the overlap.

In some embodiments, the controller is configured to derive the estimated time value associated with the second light pulse based on (1) a second piece of timing information in the trailing section of the second light pulse and (2) a peak information of the second light pulse. The controller is configured to derive the estimated time value associated with the second light pulse further based on an obtainable piece of timing information in the leading section of the second light pulse not affected by the overlap.

In some embodiments, the controller is configured to determine a piece of timing information in a trailing section of the first light pulse. The overlap can be detected based on the piece of timing information in the trailing section of the first light pulse.

In some embodiments, the controller is configured to derive the estimated time value associated with the second light pulse based on fitting data including the first piece of timing information in the trailing section of the second light pulse to an analytical model. The controller is configured to derive the estimated time value associated with the second light pulse based on a shape of the analytical model.

In some embodiments, the estimated time value associated with the second light pulse corresponds to a predetermined signal magnitude. The predetermined signal magnitude is stored in a database or lookup table.

It is also evident that, in another exemplary aspect, a light detection and ranging system is provided that includes a light emitter configured to emit an outbound light pulse, a light sensor configured to detect a first light signal indicative of a reflection of the outbound light pulse by a first object and generate a corresponding first electronic signal and detect a second light signal indicative of a reflection of the outbound light pulse by a second object and generate a corresponding second electronic signal, and a controller coupled to the light sensor that is configured to (1) detect an overlap between electronic signals representing the first and second light pulses, and (2) in response to the detection of the overlap, model the second light pulse based on a first piece of timing information in a given section of the second light pulse, wherein the given section of the second light pulse is outside of the overlap.

In some embodiments, the given section of the second light pulse is a second half of the second light pulse. The first piece of timing information in the given section of the second light pulse corresponds to a first triggering threshold.

In some embodiments, the second light pulse is modeled based on a second piece of timing information in the given section of the second light pulse, the second piece of timing information corresponding to a second triggering threshold that is different from the first triggering threshold.

In some embodiments, the controller is configured to model, in response to detecting the overlap, the first light pulse based on a first piece of timing information in a given section of the first light pulse, wherein the given section of the first light pulse is outside of the overlap. The given section of the first light pulse is a first half of the first light pulse. The first piece of timing information in the given section of the first light pulse corresponds to a first triggering threshold.

In some embodiments, the first light pulse is modeled based on a second piece of timing information in the given section of the first light pulse, the second piece of timing information corresponding to a second triggering threshold that is different from the first triggering threshold. The first light pulse can be modeled using a first model and the second light pulse is modeled using a second model that is different from the first model.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this disclosure contains many specifics, these should not be construed as limitations on the scope of the disclosure or of what may be claimed, but rather as descriptions of features that may be specific to particular embodiments of the disclosures. Certain features that are described in this disclosure in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this disclosure should not be understood as requiring such separation in all embodiments.

Only a number of implementations and examples are described and other implementations, enhancements and variations can be made based on what is described and illustrated in this disclosure.

What is claimed is:

1. A method comprising:
emitting, by a light detection and ranging (LIDAR) device, an outbound light pulse;
receiving, at the LIDAR device, a first light pulse indicative of a reflection of the outbound light pulse by an internal part of the LIDAR device;
receiving, at the LIDAR device, a second light pulse indicative of a reflection of the outbound light pulse by a surrounding object;
responsive to an overlap between electronic signals representing the first and second light pulses, deriving an estimated time value associated with the second light pulse based on a piece of timing information in a trailing section of the second light pulse; and
determining a distance of the surrounding object from the LIDAR device based on the estimated time value associated with the second light pulse.

2. The method of claim 1, wherein the estimated time value is derived without a lost piece of timing information in a leading section of the second light pulse resulting from the overlap.

3. The method of claim 1, wherein the piece of timing information in the trailing section of the second light pulse corresponds to a triggering threshold.

4. The method of claim 1, wherein:
the piece of timing information in the trailing section of the second light pulse is a first piece of timing information in the trailing section of the second light pulse; and
the deriving of the estimated time value associated with the second light pulse is further based on a second piece of timing information in the trailing section of the second light pulse.

5. The method of claim 4, wherein:
the first piece of timing information in the trailing section of the second light pulse corresponds to a first triggering threshold; and
the second piece of timing information in the trailing section of the second light pulse corresponds to a second trigger threshold that is different from the first triggering threshold.

6. The method of claim 1, wherein the deriving of the estimated time value associated with the second light pulse is further based on a piece of peak information of the second light pulse.

7. The method of claim 1, wherein the deriving of the estimated time value associated with the second light pulse is further based on an obtainable piece of timing information in the leading section of the second light pulse not affected by the overlap.

8. The method of claim 1, wherein:
the piece of timing information in the trailing section of the second light pulse is a first piece of timing information in the trailing section of the second light pulse; and
the deriving of the estimated time value associated with the second light pulse is further based on (1) a second piece of timing information in the trailing section of the second light pulse and (2) a piece of peak information of the second light pulse.

9. The method of claim 8, wherein the deriving of the estimated time value associated with the second light pulse is further based on an obtainable piece of timing information in the leading section of the second light pulse not affected by the overlap.

10. The method of claim 1, further comprising:
determining a piece of timing information in a trailing section of the first light pulse.

11. The method of claim 10, further comprising:
detecting the overlap based on the piece of timing information in the trailing section of the first light pulse.

12. The method of claim 1, wherein the deriving of the estimated time value associated with the second light pulse is based on fitting data including fitting of the piece of timing information in the trailing section of the second light pulse to an analytical model.

13. The method of claim 12, wherein the deriving of the estimated time value associated with the second light pulse is based on a shape of the analytical model.

14. The method of claim 1, wherein the estimated time value associated with the second light pulse corresponds to a predetermined signal magnitude.

15. The method of claim 14, wherein the predetermined signal magnitude is stored in a database or a lookup table.

16. A light detection and ranging system, comprising:
a light emitter configured to emit an outbound light pulse;
a light sensor configured to:
detect a first light signal indicative of a reflection of the outbound light pulse by an internal part of the system and generate a corresponding first electronic signal, and
detect a second light signal indicative of a reflection of the outbound light pulse by a surrounding object and generate a corresponding second electronic signal, the second electronic signal including a leading section and a trailing section; and
a controller coupled to the light sensor, the controller configured to (1) responsive to an overlap between electronic signals representing the first and second light pulses, derive an estimated time value associated with the second light pulse based on a piece of timing information in a trailing section of the second light pulse; and (2) determine a distance of the surrounding object from the LIDAR device based on the estimated time value associated with the second light pulse.

17. The system of claim 16, wherein the controller is configured to derive the estimated time value associated with the second light pulse without a lost piece of timing information in a leading section of the second light pulse resulting from the overlap.

18. The system of claim 16, wherein the piece of timing information in the trailing section of the second light pulse corresponds to a triggering threshold.

19. The system of claim 16, wherein:
the piece of timing information in the trailing section of the second light pulse is a first piece of timing information in the trailing section of the second light pulse; and
the controller is configured to derive the estimated time value associated with the second light pulse further based on a second piece of timing information in the trailing section of the second light pulse.

20. The system of claim 19, wherein:
the first piece of timing information in the trailing section of the second light pulse corresponds to a first triggering threshold; and
the second piece of timing information in the trailing section of the second light pulse corresponds to a second trigger threshold that is different from the first triggering threshold.
